(19) United States
(12) Patent Application Publication
(10) Pub. No.: US 2007/0247446 A1
(43) Pub. Date: Oct. 25, 2007

(54) Linear positioning input device

(76) Inventors: Timothy James Orsley, San Jose, CA (US); Jonah Harley, Mountain View, CA (US)

Correspondence Address: Kathy Manke;Avago Technologies Limited, 4380 Ziegler Road, Fort Collins, CO, 80525, US

(21) Appl. No.: 11/606,556

(22) Filed: Nov. 30, 2006

Related U.S. Application Data
(60) Provisional application No. 60/794,723, filed on Apr. 25, 2006.

(51) Int. Cl. G09G 5/00

(52) U.S. Cl. 345/184

(57) ABSTRACT

An input device of an electronic device includes a position sensor, a base, a slider, and a controller. The position sensor includes a first positioning element and a second positioning element with the first positioning element being operably coupled relative to the second positioning element. A slider includes the first positioning element. The base is configured to guide slidable movement of the slider along a single axis relative to the base and the base includes the second positioning element. The controller is configured to capture a user input based on a linear slidable position of the slider relative to the base with the linear position being determined from a position of the first positioning element relative to the second positioning element.

### CROSS-REFERENCE TO RELATED APPLICATIONS

This application claims the benefit of the filing date of Provisional U.S. Patent application Ser. No. 60/794,723, entitled “LINEAR POSITIONING INPUT DEVICE”, having Attorney Docket Number A310.278.101, and having a filing date of Apr. 25, 2006, which is incorporated herein by reference.

### BACKGROUND

Portable electronic devices, such as mobile phones, portable music players, etc., typically include a display and at least one type of input device for navigating graphical user interfaces on the display. Any one of a wide variety of conventional input devices, such as 4-way rocker switches, TouchPad™ devices, jog dials, scroll wheels, and puck-based input devices, are embedded into the portable electronic devices. Designers attempt to balance the space needs occupied by increasingly larger displays used for accommodating-video, still images, web-based applications, large data stores, document review, music list navigation, etc. against the desire for input devices that are large enough to be effective and easy to use.

In some instances, a portable electronic device includes a conventional side-mounted wheel or finger touch sensor to enable scrolling a long list of songs or other items to enable viewing the list and selecting an item from the list. In one conventional input device, once an item is selected via rotational positioning of a scroll wheel or repeated finger strokes on a touch sensor, a switch activates the selected item. Unfortunately, navigating long lists of information such as songs using these conventional side-mounted input devices is tedious for many users due to the repetitive finger or thumb motion to navigate the long lists or menus. Moreover, conventional software techniques for accelerating through long-list navigation are inadequate.

Users continue to demand more precision and accuracy in user input devices of portable electronic devices, while designers face continual pressure toward reduced size and increased functionality. With these challenges, conventional input devices continue to fall short of market expectations.

### BRIEF DESCRIPTION OF THE DRAWINGS

FIG. 1 is a top plan view of an electronic device including an input device, according to an embodiment of the invention.

FIG. 2 is a side view illustrating a display and a linear positioner of an input device, according to an embodiment of the invention.

FIG. 3A is a top plan view of a linear positioner of an input device, according to an embodiment of the invention.

FIG. 3B is top plan view of a linear positioner of an input device, according to an embodiment of the invention.

FIG. 3C is a top plan view of a detent mechanism of linear positioner of an input device, according to an embodiment of the invention.

FIG. 3D is a side view of a linear positioner of an input device, according to an embodiment of the invention.

FIG. 4 is a top plan view of a capacitive position sensor mechanism of an input device, according to an embodiment of the invention.

FIG. 5 is a graph illustrating output signals corresponding to a linear position of a slider of an input device, according to an embodiment of the invention.

FIG. 6 is a schematic diagram illustrating a circuit representing an input device, according to one embodiment of the invention.

FIG. 7A is a top plan view of a capacitive position sensor mechanism of an input device, according to an embodiment of the invention.

FIG. 7B is a side plan view of an optical position sensor mechanism of an input device, according to an embodiment of the invention.

FIG. 7C is a side plan view of a magnetic position sensor mechanism of an input device, according to an embodiment of the invention.

FIG. 8A is a top plan view of a button mechanism of a slider of an input device, according to an embodiment of the invention.

FIG. 8B is a sectional view of a button mechanism as taken along lines 8B-8B of FIG. 8A, according to an embodiment of the invention.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following Detailed Description, therefore, is not to be taken in a limiting sense, and the scope of the present invention is defined by the appended claims.

Embodiments of the invention are directed to an input device. In one embodiment, an input device is incorporated into a portable electronic device and is configured to capture user inputs associated with functions of the electronic device. In one embodiment, the input device is configured for mounting on a side edge of the electronic device (instead of mounting on a face of electronic device). In one aspect, side-mounting the input device enables the overall size of the electronic device to be smaller or for the display of the electronic device to be made larger relative to a given size of the electronic device.

In one embodiment, the input device comprises a linear positioner including a position sensor, a slider, a base and a controller. The position sensor includes a first positioning element and a second positioning element with the first positioning element being operably coupled relative to the second positioning element. In one aspect, the first positioning element is both mechanically independent from and electrically independent from (i.e., not physically connected via a wired connection) the second positioning element. The slider includes the first positioning element. The base includes the second positioning element and is configured to guide linear slidable movement of the slider along a single axis relative to the base. The controller is configured to capture a user input based on a linear slidable position of the slider relative to the base as determined by the position and/or motion of the first positioning element relative to the second positioning element.

In one embodiment, the position sensor is a capacitive position sensor while in other embodiments, the position sensor is an optical position sensor or a magnetic position sensor.

In one embodiment, the input device enables a first navigation zone and a second navigation zone. The first navigation zone is associated with a center portion of the range of linear movement of the slider relative to the base. In this first navigation zone, a position on a display of the electronic device is moved one item at a time for a corresponding single unit of movement of the slider. Accordingly, the first navigation zone enables a position control mode in which the position of the cursor (or other navigation element) is controllably moved on a discrete, one-at-a-time basis.

In another embodiment, the linear positioner comprises a detent mechanism that facilitates controlled movement of the slider on a one-at-a-time basis and for maintaining the position of the slider at a desired location.

In another aspect, the second navigation zone is associated with two end portions of the base located on opposite ends of the center portion of the range of linear movement of the slider. In this second navigation zone, a position of a cursor (or other navigation element) on the display of the electronic device is moved substantially continuously one or more items at a time as long as the slider remains positioned with one of the respective end portions of the range of linear movement of the slider. In another aspect, when the slider is in the second navigation zone, the further the slider is displaced away from its center position of linear movement, the greater the velocity of movement of the cursor across the display. Accordingly, the second navigation zone enables a velocity control mode in which the cursor (or other navigation element) moves substantially continuously based on the presence of the slider in the second navigation zone and moves at a velocity controlled by a distance of the slider away from the central portion corresponding to the first navigation zone.

In one aspect, the velocity control mode enables rapid scrolling without the conventional finger manipulations of repeated engagement and disengagement, commonly known as skating, of a conventional scroll wheel or finger touch sensor. Moreover, the sandwiching of the first navigation zone between the two portions of the second navigation zone enables seamlessly switching between the position control mode and the velocity control mode without repositioning of the finger on the slider.

In one embodiment, the slider includes a separate button or acts as a button for activating a function of the electronic device associated with a position of the cursor (or other navigable element) in the first navigation zone and/or the second navigation zone.

In one embodiment, the input device comprises a pair of first springs located within the opposite end portions of the base to provide tactile feedback when the user pushes the slider into the second navigation zone. In one aspect, the first springs are biased to cause the slider to exit the second navigation zone upon release of the slider by the user. In another aspect, the first springs are also mechanically pre-loaded to provide additional tactile feedback when transitioning between the first navigation zone and the second navigation zone.

In another embodiment, the input device additionally includes a pair of second springs (or includes a modified version the pair of first springs) to cause the slider to return to a center of the first navigation zone upon release of the slider by the user. In another aspect, the slider comprises a finger-sensing mechanism for detecting the presence of the user's finger so that no motion is reported in the first navigation zone when the user is not touching the slider.

Accordingly, various aspects of embodiments of the invention enable a low profile input device having a robust mechanism for capturing user inputs associated with a linear slidable position of a slider along a single axis.

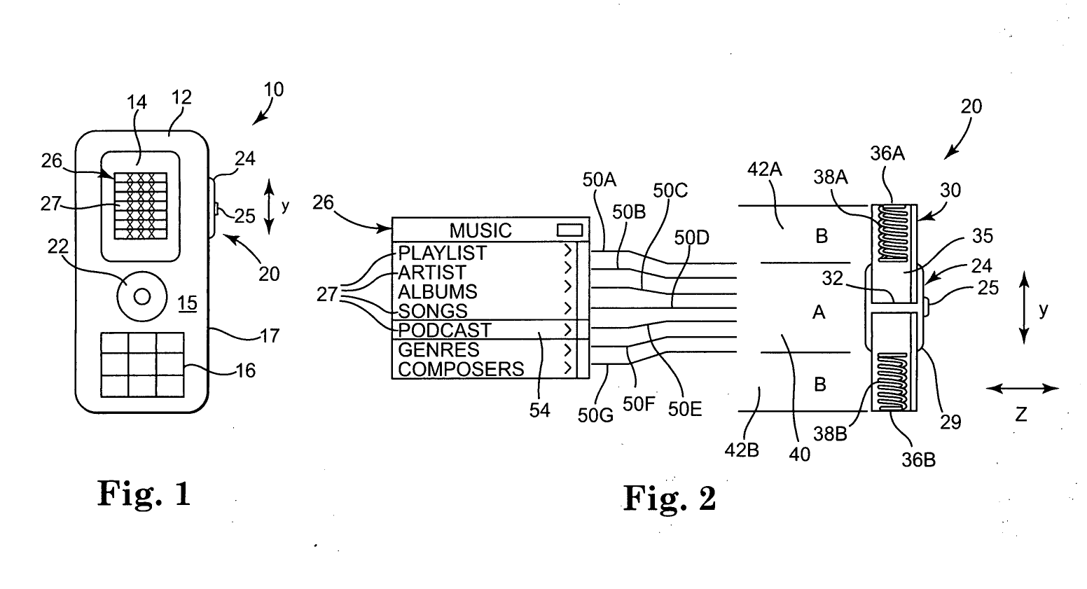

These embodiments and additional embodiments of the invention are described and illustrated in association with FIGS. 1-8B.

Embodiments of the invention are particularly well suited for implementation on portable electronic devices (e.g., mobile phones, personal digital assistants, portable audio players, etc.) having limited space for an input device or on another host apparatus such as a laptop computer. FIG. 1 is a diagram illustrating a top view of a portable electronic device 10 including an input device 20, according to one embodiment of the present invention. In one embodiment, portable electronic device 10 is a wireless mobile phone. In other embodiments, device 10 is any type of portable electronic device including an input device 20 for capturing user control inputs, including but not limited to a personal digital assistant (PDA), digital camera, portable game device, pager, portable music player, and handheld computer. In another embodiment, portable electronic device 10 is a conventional computer mouse and input device 20 is mounted between the buttons of the conventional computer mouse as a replacement for a conventional mouse scroll wheel.

As shown in FIG. 1, in one embodiment, device 10 comprises housing 12 which carries display 14, keypad 16, first input device 20, and second input device 22. In one aspect, first input device 20 comprises slider 24 with button 25. Display 14 comprises a screen capable of displaying a cursor and/or other navigation elements. In one aspect, display 14 comprises one or more elements of a graphical user interface (GUI) including, but not limited to menu 26 (or list) of items 27. Keypad 16 comprises one or more activatable keys representing numbers, letters, or other symbols. In one embodiment, input device 10 omits keypad 16.

In one embodiment, as illustrated in FIG. 1, second input device 22 mounted on a face 15 of housing 12 of electronic device 10 and comprises a 4-way rocker or scrollwheel for navigating on display 14. In other embodiments, electronic device 10 omits second input device 22. In one embodiment, first input device 20 is mounted on side edge 17 of housing 12 of electronic device 10 and configured for slidable movement of slider 24 along a single axis of movement (represented by directional arrow Y). In another embodiment, first input device 20 is mounted on face 15 of housing 12 or other location (e.g. top edge, bottom edge, back, etc.) of electronic device 10.

In one aspect, finger controlled slidable movement of slider 24 along a portion of side edge 17 of housing 12 captures user control inputs associated with electronic device 10, such as navigating and selecting functions associated with display 14. In one aspect, linear movement of slider 24 causes scrolling up or down a menu 26 of items 27 shown on display 14 or navigation of other functions of electronic device 10. In one aspect, first input device 20 comprises slider 24 with button 25 that enables activation at least one function selected or highlighted via a linear position of slider 24.

These aspects, and additional aspects of input device 20, according to embodiments of the invention, are described and illustrated in greater detail in association with FIGS. 2-8B.

FIG. 2 is a side view illustrating input device 20, according to one embodiment of the invention. As illustrated in FIG. 2, input device 20 comprises slider 24 with button 25 and base 30. In one aspect, slider 24 comprises slider housing 29 while base 30 is mounted within or on side edge 17 of housing 12 of electronic device 10.

In one embodiment, input device 20 comprises base 30 configured for containing and guiding slidable movement of slider 24 relative to housing 12 of electronic device 10 along a single axis (generally represented by directional arrow Y). In one aspect, base 30 comprises a chamber 35 including a first end 36A and a second end 36B disposed at opposite ends of chamber 35 to limit the range of slidable movement of slider 24 relative to base 30 and therefore relative to housing 12 of electronic device 10.

In one embodiment, input device 20 is configured to allow slider 24 to move within a first navigation zone 40 (also generally indicated by reference A) and a second navigation zone 42A, 42B (also generally indicated by reference B). In one aspect, first navigation zone 40 comprises a position control mode in which the highlighted portion on display 14 is moved one item at a time for each unit of linear movement of slider 24. In another aspect, second navigation zone 42A, 42B comprises a velocity control mode (e.g., joystick mode, rapid scrolling mode) with the second navigation zone 42A, 42B disposed on opposite sides of first navigation zone 40. In this velocity control mode, once slider 24 is moved into the second navigation zone 42A or 42B, items on menu 26 (in display 14 of FIG. 1) are viewable one or more items at a time with the items scrolling though menu 26 in a substantially continuous manner. In another aspect, with slider 24 positioned in this second navigation zone (42A, 42B), items in menu are moved successively a set at a time to define a window scrolling mode.

In another aspect, once a user identifies a desired set of items via scrolling in a velocity control mode in the second navigation zone 42A, 42B, the user moves slider 24 into the first navigation zone 40 to enable a position control mode (e.g., 1:1 mode) to move one item at a time within the selected set of items on menu 26 (viewed in display 14) until the desired item of menu 26 is selected or highlighted on display 14.

FIG. 2 further illustrates aspects of the first navigation zone 40 in which items 27 on display 26 correspond respectively to specific units of linear position within the first navigation zone 40 (as represented by lines 50A-50G). In one aspect, this arrangement comprises a position control mode in which each single unit (e.g., units 50A-50G) of linear movement of slider 24 directly corresponds to movement of a cursor (or navigation element, such as a highlighter) on menu 26 of display 14 up or down by only a single position or item. In one aspect, as illustrated in FIG. 2, highlighted item 54 on menu 26 of display 14 corresponds to linear positional input 50E of slider 24.

In one embodiment, in the first navigation zone, the menu 26 viewable on display 14 of device 10 includes a dynamic space allocation for items 27 listed on menu 26. In one aspect, as shown in FIG. 2, a number “n” of items 27 are listed with each item 27 occupying 1/n^{th} of the available space for menu 26 on display 14. In the example, shown in FIG. 2, seven items are listed on menu 26. In another aspect, upon activation of one of the listed items 27, such as item 54 (“podcasting”), a different number of items are displayed as menu 26. For example, with the activation of highlighted item 24, twelve items 27 appear on menu 26 with each item 27 occupying about 1/12^{th} of the available space for menu 26. Accordingly, with this embodiment of dynamic space allocation for items 27, menu 26 of items 27 is not limited to a single, static number “n” of items 27 viewable on display 14 of electronic device 10.

In one embodiment, a controller of electronic device 10 or of input device 20 (such as controller 206 in FIG. 6) controls the dynamic space allocation for items 27 and determines a minimum number “n” or a maximum number “n” of items 27 that can be displayed on menu 26 of display 14 of electronic device 10. In another embodiment, a controller of electronic device 10 or of input device 20 determines the dynamic space allocation for items 27 on display 14 based on the type of item to be displayed. In one non-limiting example, one type of item 27 is a video with a video menu 26 including a space allocation of five items 27 with each item 27 occupying ⅕^{th} of the available space on menu 26. In another non-limiting example, one type of item is a song with a song menu including a space allocation of ten items with each item 27 occupying 1/10^{th} of the available space on menu 26.

In one embodiment, slider 24 is frictionally engaged relative to base 30 so that once slider 24 is moved to a given linear position within the first navigation zone 40, slider 24 remains in that position.

In one embodiment, input device 20 comprises a resilient mechanism such as springs 38A, 38B disposed at opposite ends of base 30 to provide tactile feel to a user during linear slidable movement of slider 24 in at least one portion of the range of slidable movement. In one aspect, the position of springs 38A, 38B in chamber 35 of base 30 generally corresponds with the position of the second navigation zone 42A, 42B so that upon movement of slider 24, mid bar 32 of slider 24 contacts either spring 38A, 38B to identify to a user (by tactile feel) entry into the velocity control mode associated with the second navigation zone 42A, 42B.

In another aspect, the velocity control mode of the second navigation zone 42A, 42B corresponds to a rate zone or a joystick zone in which a list or menu 26 on display 14 continues to scroll whenever the slider 24 is in the second navigation zone 42A, 42B. In this arrangement, when the user releases the slider 24, springs 38A, 38B act to force slider 24 out of the second navigation zone 42A, 42B into the first navigation zone 40. This mechanism prevents the list or menu 26 on display 14 from scrolling when no one is touching the slider 24.

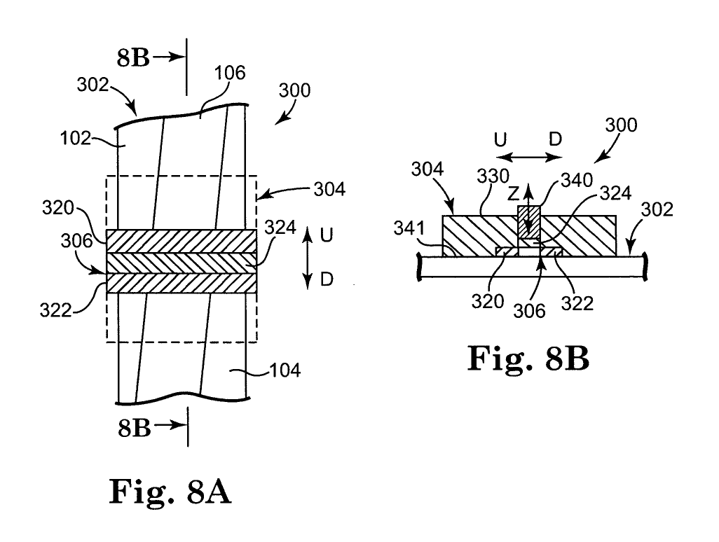

In one embodiment, the slider 24 of input device 20 comprises a button 25 for activating a function of the electronic device 10 associated with a position of the cursor (or other navigable element) on menu 26 of display when the slider 24 is located in the first navigation zone 40 or the second navigation zone 42A, 42B. In one aspect, button 25 is moved inward toward housing 12 along z-axis to activate the desired function. Additional embodiments of button 25 are described in more detail in association with FIGS. 8A and 8B.

In another aspect, when the slider 24 is within the second navigation zone 42A, 42B, the further the slider 24 is moved toward the end of the second navigation zone 42A, 42B, the greater the velocity of the scrolling across menu 26 of display 14 with the velocity being proportional to the distance that the slider 24 is positioned away from the centrally located, first navigation zone 40.

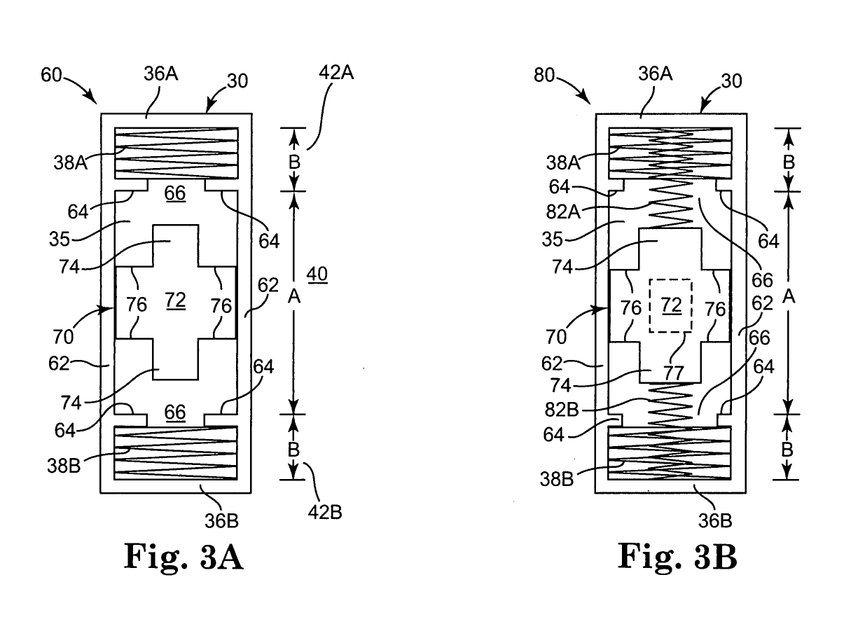

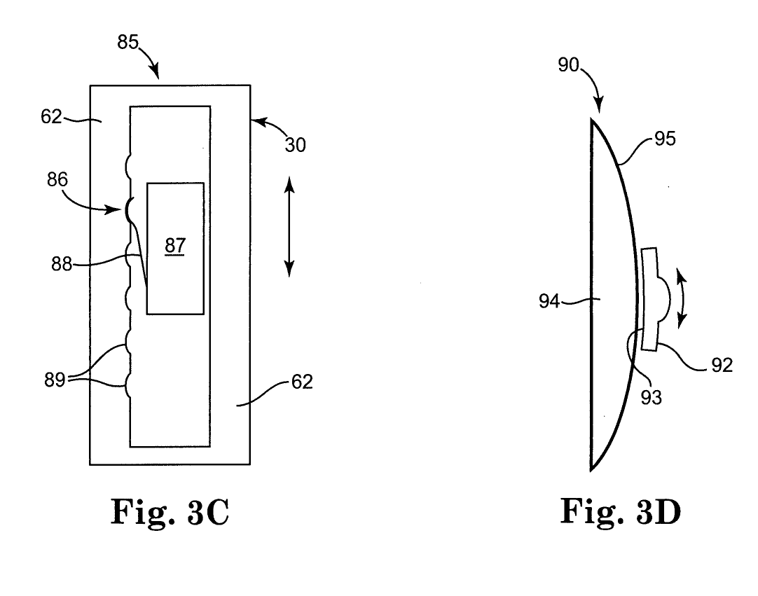

FIG. 3A is a top plan view of a linear positioner of an input device, according to an embodiment of the invention. As illustrated in FIG. 3A, in one embodiment, input device 60 comprises substantially the same features and attributes as input device 20 as previously described and illustrated in association with FIGS. 1-2, except additionally comprising a differently shaped slider 70 and mechanical stops 64. In one aspect, input device 60 defines a linear positioner that comprises base 30, which includes side wall 62 and a pair of mechanical stops 64 disposed on each respective side wall 62 adjacent the respective ends 36A, 36B of base 30. Each pair of mechanical stops 64 are positioned on opposite sides of slider 70 and define a gap 66.

In one aspect, slider 70 comprises body 72 and a pair of fingers 74 extending outward in opposite directions from each other relative to body 72. Slider 70 also includes lateral contact portions 76 which extend laterally outward on opposite sides of each respective finger 74 of slider 70. Each finger 74 is sized to slidably pass through gap 66 while mechanical stops 64 are positioned to releasably engage lateral contact portions 76 of slider 70 to limit the range of motion of slider 70 against the respective springs 38A, 38B. Mechanical stops 64 are positioned to cause a pre-load on springs 38A, 38B so that upon an end of finger 74 contacting one of the springs 38A, 38B, the user experiences a sudden change in force that is easily discernable to the user as the user moves the slider 24 from the first navigation zone (A) 40 to second navigation zone (B) 42A, 42B. This tactile feedback facilitates user awareness of the transition between the first navigation zone 40 and the second navigation zone 42A, 42B.

FIG. 3B is a top plan view of a linear positioner of an input device, according to an embodiment of the invention. As illustrated in FIG. 3B, in one embodiment, input device 80 comprises substantially the same features and attributes as input device 60 as previously described and illustrated in association with FIG. 3A, except additionally comprising re-centering springs 82A, 82B as part of the linear positioner. In this embodiment, upon the user moving slider 24 to a non-central position of its slidable range along base 30, re-centering springs 82A, 82B act to return the slider 24 to the center position of the first navigation zone (A) 40.

In another embodiment, as illustrated in FIG. 3B slider 24 additionally comprises a sense detection mechanism 77 to sense the presence of the user's finger on the slider 24. Accordingly, in one aspect, the cursor control on display 14 is disabled upon the sense detection mechanism detecting that the user has released slider 24, thereby preventing the selection on display 14 from moving from its selected position to the center of the display 14.

As illustrated in FIG. 3B, in one embodiment, re-centering springs 82A, 82B extend concentrically within and generally parallel to springs 38A, 38B so that springs 38A, 38B still provide a tactile distinction between the first navigation zone 40 and the second navigation zone 42A, 42B. In one aspect, as illustrated in FIG. 3B, mechanical stops 64 still act to place a pre-load on springs 38A, 38B to provide tactile feedback when transitioning between the first navigation zone 40 and the second navigation zone 42A, 42B as previously described in association with FIG. 3A.

However, in another embodiment, the force profile of the combination of spring 82A and spring 38A is achieved via a single spring having a non-linear spring constant, in a manner apparent to those skilled in the art. Likewise, the force profile of the combination of spring 82B and spring 38B is achieved via a single spring having a non-linear spring constant, in a manner apparent to those skilled in the art.

FIG. 3C is a top plan view of a linear positioner of an input device 85 including a detent mechanism 86, according to one embodiment of the invention, for providing tactile feedback when moving slider 24 from item to item on the menu 26 on display 14. As illustrated in FIG. 3C, input device 85 comprises base 30 and slider 87 having substantially the same features and attributes as input devices 20, 60, 80 (as previously described in association with FIGS. 1-3B), except further including detent mechanism 86. Detent mechanism 86 comprises scallops 89 and spring 88. Scallops are formed in series along side wall 62 of base 30 while spring 88 is disposed on slider 87 and is sized and shaped for slidable movement along side wall 62 from scallop 89 to scallop 89. In another aspect, spring 88 is biased to engage each respective scallop 89 along side wall 62 of base 30 while being selectively slidably movable along side wall 62. In another aspect, one or more scallops 89 are used to indicate a transition zone between the first navigation zone 40 and the second navigation zone 42A, 42B (see FIGS. 2, 3A-3D).

FIG. 3D is a side view of a linear positioner of an input device, according to an embodiment of the invention. As illustrated in FIG. 3D, input device 90 comprises a linear positioner having substantially the same features and attributes as input devices 20, 60, and 80 (as previously described in association with FIGS. 1-3C), except further comprising a generally curved arrangement in which a slider 92 has a curved contact surface 93. In this embodiment, a base 94 has a curved surface 95 sized and shaped to enable slider 92 (via curved contact surface 93) to slidably move, in a reciprocal manner, relative to the curved surface 95 of base 94. In one aspect, this linear positioner 90 is adapted for incorporation into portable electronic devices that have a generally disc shaped or circular shaped body.

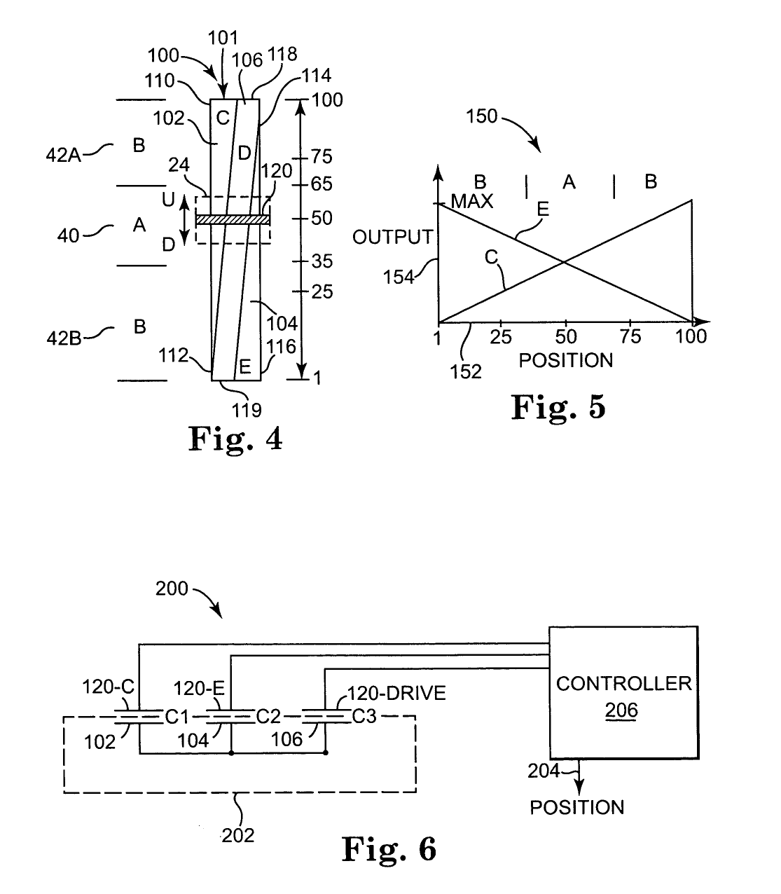

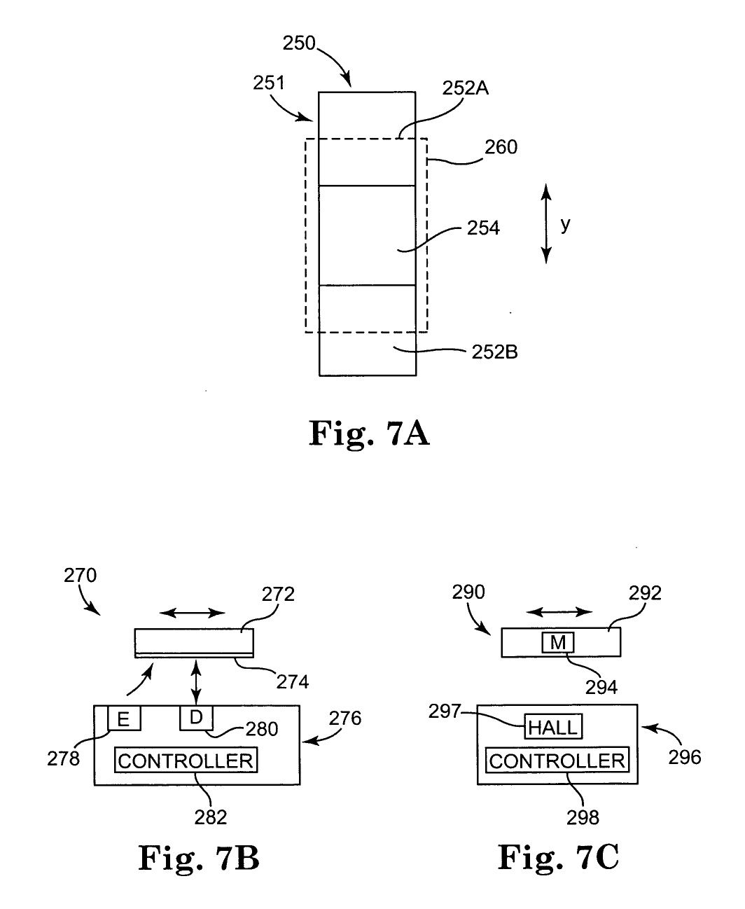

Embodiments of the invention use any one of various position sensor mechanisms, in association with input devices 20, 60, 80, 85, 90, to capture user control inputs. In one embodiment, a position sensor mechanism includes a capacitive-based position sensing mechanism as described in association with FIG. 4-7A. In another embodiment, a position sensor mechanism includes an optically based position sensing mechanism as further described later in association with FIG. 7B. In another embodiment, a position sensor mechanism includes a magnetic-based position sensing mechanism as further described later in association with FIG. 7C.

FIG. 4 is a top plan view of a capacitive-based position sensor mechanism 100 of an input device, according to one embodiment of the invention. In one embodiment, position sensor mechanism 100 comprises substantially the same features and attributes as input devices 20, 60, 80, 85, and 90 (as previously described in FIGS. 1-3D).

In one embodiment, position sensor mechanism 100 comprises electrode base 101 and conductive slider bar 120, which are operably coupled together. In one aspect, conductive slider bar 120 comprises a first positioning element and electrode base 101 comprises a second positioning element. In one aspect, electrode base 101 defines a generally stationary bottom portion of a generally two-part input device with conductive slider bar 120 comprising an upper portion of the input device, although the input device is not strictly limited to two parts. In one aspect, conductive slider bar 120 comprises a portion of slider 24 previously described in association with FIGS. 2-3D. In one embodiment, electrode base 101 is formed by arranging conductive traces or pads on a printed circuit board with the printed circuit board comprising an integrated circuit configured to drive and control a signal through the electrode portions of electrode base 101.

In one embodiment, as illustrated in FIG. 4, electrode base 101 comprises a generally rectangular elongate member including an array of electrodes which are electrically isolated from each other. In one embodiment, this array includes first sense electrode 102 (also represented by reference C), second sense electrode 104 (also represented by reference E), and drive electrode 106. First sense electrode 102 and second sense electrodes 104 are disposed on opposite sides of drive electrode 106. In one aspect, each respective first sense electrode 102 and second sense electrode 104 is generally triangular shaped.

In one aspect, first sense electrode 102 comprises first end 112 and second end 110 with first end 112 comprising a first vertex of a right angle triangle and second end 110 a side of the right angle triangle disposed opposite the first vertex.

In one aspect, second sense electrode 104 comprises first end 114 and second end 116, with first end 114 comprising a first vertex of the generally right angle triangle shaped electrode 104 and the second end 116 comprising a side of the right angle triangle shape opposite the first vertex. Accordingly, the cross sectional area of each sense electrode 102, 104 varies from approximately zero adjacent the first end of the respective sense electrodes 102, 104 to a maximum cross-sectional area adjacent the second end of the respective sense electrodes 102, 104.

In one aspect, drive electrode 106 comprises first end 118 and second end 119 and comprises a generally parallelogram shaped member. In one aspect, the cross sectional area of drive electrode 106 remains substantially constant from its first end 118 to second end 119. In another aspect, first sense electrode 102 and second sense electrode 104 are oriented in opposite directions so that the first vertex (i.e., first end 112) of first sense electrode 102 points in an opposite direction from first vertex (i.e., first end 114) of second sense direction 104.

In one aspect, conductive slider bar 120 comprises a generally rectangular shaped bar that is vertically spaced and slidably movable relative to electrode base 101 and oriented transversely relative to a longitudinal axis of electrode base 101. As illustrated in FIG. 4, conductive slider bar 120 of position sensor mechanism 100 is slidably movable along a linear orientation relative to electrode base 101 in either a first direction (as indicated by directional arrow U) or a second opposite direction (as indicated by directional arrow D). In one aspect, a downward sliding movement (direction D) of conductive slider bar 120 is used to capture user inputs associated with scrolling downward on menu 26 of display 14 of electronic device 10 in FIG. 1 while an upward sliding movement of conductive slider bar 120 is used to capture user inputs associated with scrolling upward on menu 26.

In one aspect, conductive slider bar 120 comprises a passive conductive element that is not tied to ground or a signal source, thereby electrically floating relative to electrode base 101. Accordingly, conductive slider bar 120 is both mechanically and electrically independent of electrode base 101. Upon application of an input signal via drive electrode 106 of electrode base 101, the conductive bar 120 acts to capacitively couple the drive electrode 106 to the respective first and/or second sense electrodes 102, 104.

In one aspect, upon application of an input signal via drive electrode 106, capacitive coupling of the drive electrode 106 through the conductive slider bar 120 relative to the first sense electrode 102 produces an output signal C and capacitive coupling of the drive electrode 106 through the conductive slider bar 120 relative to the second sense electrode 104 produces an output signal E.

FIG. 5 is a diagram illustrating a magnitude of an output signal C (e.g., first sense electrode 102) and an output signal E (e.g., second sense electrode 104) that indicated a position of slider 24 detected via position sensor mechanism 100. As illustrated in FIG. 5, an x-axis 152 represents a linear position of slider 24 relative to electrode array 101 and a y-axis 154 represents the magnitude of the respective output signals C, E.

The magnitude of the respective output signals C and E corresponds to the extent to which the conductive slider bar 120 (of slider 24) overlaps each of the respective first and/or second sense electrodes 102, 104. In one aspect, the slope of the magnitude of output signal C generally corresponds to the cross-sectional area of the first sense electrode 102 that varies in an increasing manner from the first end to the second end of the electrode array 101. In another aspect, the slope of the magnitude of output signal E generally corresponds to the cross-sectional area of the second sense electrode 104 that varies in an increasing manner from the second end to the first end of the electrode array 101. Accordingly, the varying cross-sectional area of the first sense electrode 102 and the second sense electrode 104 along a length of electrode array 101 enables determining a linear position of conductive slider bar 120 via the value of the output signals C and E.

In one aspect, an electrode array 101 of an input device (e.g., input device 20 of FIGS. 1-6) can have different electrode pattern layouts, such as those illustrated and described later in association with FIG. 7A, as well as other electrode patterns ascertainable by those skilled in the art.

In another aspect, as illustrated in association with FIGS. 4-5, an array of user inputs are associated with one or more parameters (e.g., magnitude, slope, etc.) of the output signals C and E to yield a known and selectable variable number of user inputs (e.g., 8, 10) corresponding to the range of linear positioning of conductive slider bar 120 (of slider 24) within first navigation zone 40 (FIG. 2-3). In one aspect, an absolute position of the conductive slider bar 120 is determined via a comparison of the magnitude of signal C, corresponding to first sense electrode 102, and the magnitude of signal E, corresponding to second sense electrode 104.

As illustrated in FIG. 5, the magnitude of output signal C varies increasingly from a minimum at one end (e.g., linear position 1) to a maximum at the other end (linear position 100) of the range of linear movement of conductive slider bar 120 and the magnitude of output signal E varies in an opposite manner, decreasing from a maximum at one end (e.g., linear position 1) to a minimum at the other end (linear position 100) of the range of linear movement of conductive slider bar 120.

In one aspect, if an input scale of 1 to 100 were assigned to the full range of slidable movement of conductive slider bar 120 as illustrated in FIGS. 4-5, then a particular magnitude of output signals C and E is assigned to each respective input value. In another aspect, the first navigation zone 40 (represented by reference A) is assigned to a particular value range such as between 35 and 65 input range values (or other values such as 25 and 75 respectively). In this position, each incremental movement of the conductive slider bar 120 corresponds directly to one positional movement (or one item at a time) on a menu 26 or list, as previously illustrated and described in association with FIG. 2. On the other hand, when conductive slider bar 120 is positioned outside the first navigation zone 74, a cursor controlled via linear positioner 100 becomes subject to parameters of the second navigation zone 42A, 42B (represented by reference B) such as a velocity control mode.

In another aspect, the determination of the position of conductive slider bar 120 (of slider 24) will generally be based on: (1) a difference between output signal C and output signal E; (2) the ratio of output signal C and output signal E; or (3) the difference of output signal C and output signal E divided by the sum of output signal C and output signal E. In this latter determination, normalizing by the sum eliminates the capacitance dependence on the gap of sense conductor 120 from electrodes 102, 104 and 106, provided the gap is approximately equal for all three.

FIG. 6 is a diagram illustrating an equivalent circuit 200 corresponding to the interaction between a conductive slider bar 120 and the respective electrodes 102-106 of electrode base 101 (shown in FIG. 4), according to one embodiment of the invention. In one aspect, as illustrated in FIG. 6, the overlap of conductive slider bar 120 relative to electrodes 102, 104, 106 are represented by electrodes 120-C, 120-E, and 120-DRIVE, respectively. The portion of conductive slider bar 120 that overlaps first sense electrode 102 forms a parallel plate capacitor having a capacitance C1 that is proportional to that overlap. Similarly, the portion of conductive bar 120 that overlaps second sensor electrode 104 forms a parallel plate capacitor that has a capacitance C2 that is proportional to that overlap, and so on. Because all of the capacitors share portions of conductive bar 120, the equivalent circuit 200 consists of three capacitors connected to a common electrode conductor shown at 202, corresponding to conductive slider bar 120 in FIG. 6. By measuring the overlap capacitance between conductive slider bar 120 and each respective sense electrode 102, 104 (when driven to a voltage potential), the linear position of conductive slider bar 120 relative to sense electrodes 102, 104 can be determined.

In one embodiment, this position determination is made by a controller 206, which may be part of the input device 20 (FIG. 1), or part of the electronic device 10 of which the input device 20 forms a part. In one embodiment, controller 206 produces a signal 204, which identifies the current position of the conductive slider bar 120.

It will be understood by a person of ordinary skill in the art that functions performed by controller 206 may be implemented in hardware, software, firmware, or any combination thereof. The implementation may be via a microprocessor, programmable logic device, or state machine. Components of the present invention may reside in software on one or more computer-readable mediums. The term computer-readable medium as used herein is defined to include any kind of memory, volatile or non-volatile, such as floppy disks, hard disks, CD-ROMs, flash memory, read-only memory (ROM), and random access memory.

FIG. 7A is a top plan view of a capacitive position sensor mechanism 250 of an input device, according to an embodiment of the invention. In one embodiment, position sensor mechanism 250 comprises generally the same features and attributes associated with position sensor mechanism 100, as described in association with FIGS. 4-6 except with position sensor mechanism 250 having a different geometric pattern of its respective sense electrodes and drive electrode. Accordingly, in one aspect, position sensor mechanism 250 determines a position of a slider along a single axis of movement (represented by directional arrow Y).

As illustrated in FIG. 7A, position sensor mechanism 250 comprises electrode array 251 and conductive slider 260. In one aspect, conductive slider 260 comprises a first positioning element and electrode array 251 comprises a second positioning element that is operably coupled relative to the first positioning element. Electrode array 251 comprises central drive electrode 254 interposed between sense electrodes 252A, 252B. In a manner substantially the same as for the position sensor mechanism 100 as previously described in association with FIG. 4, conductive slider 260 acts to conductively couple drive electrode 254 relative to the sense electrodes 252A, 252B. In one aspect, slidable motion of the conductive slider 260 along the single axis in either direction will yield a linearly increasing signal in one of the respective sense electrodes 252A, 252B and a linearly decreasing signal in the other respective sense electrode 252A, 252B channel. Accordingly, in one aspect, position sensor mechanism 250 produces output signals substantially corresponding to the output signals C and E previously illustrated in FIG. 5.

In another embodiment, an optical position sensor mechanism 270 illustrated in FIG. 7B is substituted for capacitive position sensor mechanism 250 of FIG. 7A or position sensor mechanism 100 of FIG. 4. FIG. 7B is a side view of an optical position sensor mechanism 270 of an input device, according to an embodiment of the invention. As illustrated in FIG. 7B, position sensor mechanism 270 comprises slider 272 with reflective pattern 274 and stationary optical sensor 276. In one aspect, reflective pattern 274 of slider 272 comprises a first positioning element and stationary optical sensor 276 comprises a second positioning element that is operably coupled relative to the first positioning element. In one aspect, slider 272 comprises the reflective pattern 274 on its bottom surface while stationary optical sensor 276 comprises emitter 278, detector 280, and controller 282. Using known principles of optical navigation, movement of reflective pattern 274 on slider 274 relative to the emitter/detector pair of stationary optical sensor 276 enables a determination of movement of slider 272 along a single axis to produce a pattern of output signals generally corresponding to the output signals C, E in FIG. 5. These output signals associated with a position of slider 272, in first navigation zone 40 or second navigation zone 42A, 42B, are used to control a cursor on display 14 (FIGS. 1-2).

In another embodiment, a magnetically-based position sensor mechanism 290 illustrated in FIG. 7C is substituted for capacitive-based position sensor mechanism 250 of FIG. 7A or position sensor mechanism 100 of FIG. 4. FIG. 7C is a side view of a magnetically-based position sensor mechanism 290 of an input device, according to an embodiment of the invention. As illustrated in FIG. 7C, position sensor mechanism 290 comprises slider 292 including magnetic element 294 and magnetic sensor 296, which includes one or more Hall Effect sensors 297 (or other magnetic position sensor) and controller 298. In one aspect, magnetic element 294 of slider 292 comprises a first positioning element and Hall Effect sensor 297 comprises a second positioning element that is operably coupled relative to the first positioning element. Movement of magnetic element 294 of slider 292 relative to the Hall Effect sensor 297 of sensor 296 enables a determination of position and/or movement of slider 292 along a single axis to produce a pattern of output signals generally corresponding to the output signals C, E in FIG. 5. These output signals associated with a position of slider 292, in first navigation zone 40 or second navigation zone 42A, 42B, are used to control a cursor on display 14 (FIGS. 1-2).

As previously described in association with FIG. 2, slider 24 of input device 20 includes button 25 for activating a function of an electronic device 10 when slider 24 is in a desired position in either a first navigation zone 40 or second navigation zone 42A, 42B. In this embodiment, the button 25 comprises conductive slider bar 120 (FIG. 4), which is moved closer to the sense electrodes 102, 104 and/or drive electrode 104 during pressing of button 25 of slider 24. This action causes an increase in the magnitude of the output signals C and E, which is captured as activation of a function of the portable electronic device based on the linear position of the slider 24 at the time the button 25 was activated.

FIGS. 8A and 8B illustrate another embodiment of a button of an input device for activating a function of an electronic device in association with the position of a slider movable along a single axis. Accordingly, FIG. 8A is a top plan view of a capacitive position sensor mechanism 300 that includes a slider 304 with a button mechanism 306, according to an embodiment of the invention. As illustrated in FIG. 8A, position sensor mechanism 300 comprises electrode base 302 and slider 304 including button mechanism 306. In one embodiment, electrode base 302 comprises substantially the same features and attributes as electrode base 101 as previously described and illustrated in association with FIG. 4. In one aspect, slider 304 comprises housing 330 (shown in dashed lines), as further described and illustrated in association with FIG. 8B.

As illustrated in FIG. 8A, button mechanism 306 incorporates a conductive bar pair that includes first conductive bar 320 and second conductive bar 322 that are spaced apart from each other along a direction generally parallel to the direction of linear sliding. In a manner substantially the same as conductive slider bar 120 of linear positioner 100, linear movement of conductive bars 320, 322 relative to the linearly varying cross-sectional area of the respective first and second sense electrodes 102, 104 enables determining the linear position of slider 304 relative to electrode array 302

In one embodiment, button mechanism 306 additionally comprises third conductive bar 324 interposed between first conductive bar 320 and second conductive bar 322 and configured for removably engaging electrode bar 302 to activate a function of electronic device 10, as further described in association with FIG. 8B. In another aspect, the three bars 320, 322 and 324 may be electrically connected, or not, as desired.

FIG. 8B is a sectional view of FIG. 8A, as taken along lines 8B-8B, according to one embodiment of the invention. As illustrated in FIG. 8B, in one embodiment, slider 304 comprises housing 330 supporting vertically slidable movement of button 340. In one aspect, a bottom portion of button 340 supports third conductive bar 324 with conductive bars 320,322 being mounted adjacent bottom portion 341 of housing 332.

In one aspect, button 340 and its associated third conductive bar 324 is movable between an at rest position and in-use position, with the in-use position corresponding to activation of a function of electronic device 10 and the at-rest position corresponding to a neutral function—without activating a function of the electronic device. In another aspect, the function of the electronic device 10 comprises activating a selected or highlighted item 94 on menu 26 of display 14 of electronic device 10 (FIG. 2).

In one aspect, upon pressing button 340 to an in-use position, third conductive bar 324 is moved into contact with, or closely adjacent to, electrodes 102-106 of electrode base 302 which substantially increases the magnitude of the output signal(s) produced via capacitive coupling of third conductive bar 324 relative to the respective electrodes 102-106 of electrode base 302. Upon detection of a substantial increase in the output signal associated with the pressing of button 340, controller of input device 20 activates a function of electronic device, such as activating a selection made via linear positioning of slider 304 to highlight or select an item 27 on menu 26 (FIG. 2). Upon releasing the button 340, the output signals C, E (FIG. 5) associated with electrodes 102-106 of electrode base 302 return to their state associated with the linear position of conductive bars 320,322. Because the difference of signals C and E is normalized by the sum of the signals, the position information is not affected by the clicking.

In another embodiment, button mechanism 306 is configured to trigger different functions of slider 304 and/or an electronic device 10 based on multiple thresholds of the output signals corresponding to the distance between the button 340 and the sense electrodes 102, 104 as button 340 approaches the sense electrodes 102-104. In one aspect, a first output threshold for button mechanism 306 provides a “touch” sensing function previously described in association with FIG. 3B regarding enabling and disabling cursor control in cooperation with the re-centering action of re-centering springs 82A, 82B. In another aspect, another output threshold for button mechanism 306 generally corresponds to a click function associated with selection of a function of the electronic device 10. In one aspect, the click function is further enabled via an integrated mechanical element such as a dome switch to provide a tactile feel associated with the selection. In another aspect, activating button 340 does not prevent motion of the slider. In this manner, click-and-drag operations are achieved, as with a traditional mouse.

Embodiments of the invention provide a robust input device configured to capture user inputs via linear positioning of a slider. In one embodiment, side mounting of the input device conserves space on the face of the electronic device to enable more space for larger displays or to enable an electronic device with a smaller footprint. In another aspect, providing a slider bar with a first navigation zone and a second navigation zone overcomes the repetitive annoyance of thumb repositioning on a conventional side-mounted scroll wheel or finger skating on a conventional capacitive side-mounted finger touch sensor.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. An input device of an electronic device comprising:
a position sensor including a first positioning element and a second positioning element with the first positioning element being operably coupled relative to the second positioning element, the first positioning element being mechanically independent and comprising an electrically passive element;
a slider including the first positioning element;
a base configured to guide slidable movement of the slider along a single axis relative to the base, the base including the second positioning element; and
a controller configured to capture a user input based on a linear slidable position of the slider relative to the base, the linear position being determined from a position of the first positioning element relative to the second positioning element.

2. The input device of claim 1 and further comprising an electronic device in which the input device is mounted on a side edge of a housing of the electronic device and a display is mounted on at least one of a front portion and a rear portion of the electronic device.

3. The input device of claim 2 wherein the display is sized and shaped to occupy substantially the entire surface area of the respective front portion and rear portion which the display is mounted.

4. The input device of claim 1 wherein the base comprises:
a central portion generally corresponding to a first navigation zone in which a single unit of linear movement of the slider directly corresponds to a single unit of linear movement of a position on a display of an electronic device; and
a pair of end portions disposed on opposite sides of the central portion of the base and generally corresponding to a second navigation zone in which positioning the slider within the second navigation zone causes substantially continuous cursor movement on a display of an electronic device and in which a velocity of cursor movement is controlled by a distance that the slider is spaced from the central portion of the base.

5. The input device of claim 4 and further comprises:
a detent mechanism including:
a series of detents disposed on a base; and
a spring disposed on a body of the slider and configured to slidably engage the series of detents wherein each respective detent directly corresponds to a discrete input position of the first navigation zone.

6. The input device of claim 4 wherein the base comprises a chamber and a pair of first spring elements that are mechanically independent of the slider, each first spring element housed within a respective end portion of the chamber and each first spring element having a length generally corresponding to a length of the second navigation zone at each respective end portion of the input device.

7. The input device of claim 6 wherein the base comprises a pair of second spring elements that extend generally parallel to the first spring elements, each second spring element including a first end and a second end with the first end in contact with an end wall of the chamber and the second end of the second spring element mechanically secured to the slider.

8. The input device of claim 6 wherein the chamber of the base comprises a side wall that defines at least one mechanical stop positioned to retain the first spring elements in a pre-loaded state prior to releasable contact of the slider relative to the first spring element, wherein the at least one mechanical stop is located at a transition point between the first navigation zone and the second navigation zone.

9. The input device of claim 1 wherein the position sensor comprises a capacitive position sensor with the second positioning element including an electrode array, the electrode array including a pair of sense electrodes and a drive electrode interposed between the respective sense electrodes, the first positioning element of the capacitive position sensor acting to conductively couple the drive electrode relative to the sense electrodes.

10. The input device of claim 9 wherein the sense electrodes define a first sense electrode and a second sense electrode and the first sense electrode and the second sense electrode are disposed on opposite sides of the drive electrode.

11. The input device of claim 10 wherein the cross-sectional area of the first sense electrode varies increasingly from the first end to the second end of the electrode array of the base and the cross-sectional area of the second sense electrode varies increasingly from the second end to the first end of the electrode array of the base, and
wherein the drive electrode comprises a substantially uniform cross-sectional area from the first end to the second end of the electrode base.

12. The input device of claim 1 wherein the conductive element is an electrically passive element electrically isolated from at least one of a ground reference and a direct connection to a drive signal.

13. The input device of claim 1 wherein the position sensor comprises an optical position sensor with the first positioning element comprising a reflective patterned surface and the second positioning element comprising an optical sensor module, the optical sensor module comprising an emitter and a detector.

14. The input device of claim 1 wherein the position sensor comprises a magnetic position sensor with the first positioning element comprising a magnetic element and the second positioning element comprising a magnetic field detector.

15. The input device of claim 1 and further comprising:
a slider including a housing; and
at least one of a click sensor and a touch sensor.

16. A method of capturing user inputs for an electronic device, the method comprising:
mounting an electrically passive bar in a spaced relationship to and for linear slidable movement relative to a stationary electrode base;
arranging the stationary electrode base with a drive electrode interposed between a first sense electrode and a second sense electrode and capacitively coupling, via the electrically passive bar, the sense electrodes relative to the drive electrode; and
capturing a user input to control a navigation element on a display of an electronic device based on a linear position of the electrically passive bar along a single axis of motion relative to the respective sense electrodes and the drive electrode.

17. The method of claim 16 wherein arranging the stationary electrode base includes:
providing a first navigation zone at a central portion of the stationary electrode base and a second navigation zone at opposite ends of the central portion of the stationary electrode base; and
capturing user inputs in a position control mode in the first navigation zone and in a velocity control mode in the second navigation zone.

18. The method of claim 16 and further comprising:
activating a function of the electronic device, based on the linear position of the electrically passive bar relative to the stationary electrode base, via movement of a button toward the stationary electrode base along a second axis of motion.

19. The method of claim 18 wherein the button comprises at least one of the electrically passive bar and a second electrically passive bar positioned adjacent the electrically passive bar.

20. An electronic device comprising:
a housing including a face portion and a side edge with the face portion comprising a display; and
an input device including:
a base;
a slider mounted on the side edge of the housing and configured for slidable movement relative to the base along a single axis of motion,
a position sensor disposed relative to the base and relative to the slider to capture user inputs, based on slidable movement of the slider relative to the base, for controlling at least one navigation element on the display of the electronic device; and
a controller configured to provide:
a first navigation zone governing inputs in a central movement range of the position sensor and in which each unit of movement of the slider directly corresponds to each unit of movement of the at least one navigation element; and
a second navigation zone governing inputs in a pair of end positioning ranges of the position sensor and in which the presence of the slider in the second navigation zone causes substantially continuous scrolling of the at least one navigation element,
wherein the first navigation zone is interposed between two opposite end portions defining the second navigation zone.

21. The electronic device of claim 20 and further comprising a pair of springs with each respective spring disposed within the base at opposite ends of the base and with each respective spring positioned to define a transition point between the first navigation zone and the second navigation zone, the springs being biased to return the slider to the first navigation zone.

22. The electronic device of claim 20 wherein the position sensor comprises at least one of a capacitive position sensor, an optical position sensor and a magnetic position sensor wherein each respective position sensor comprises a first positioning element incorporated into the slider and a second positioning element incorporated into the base.

22. The electronic device of claim 20 wherein the controller is configured to dynamically allocate space to each item viewable in the first navigation zone on the display based on at least one of: (1) a type of item to be displayed; and (2) a number of items to be displayed.
